(19) United States
(12) Patent Application Publication
(10) Pub. No.: US 2005/0200137 A1
(43) Pub. Date: Sep. 15, 2005

(54) Latch apparatus and method

(76) Inventors: James Nelsen, Howell, MI (US); Timothy S. O'Callaghan, Fenton, MI (US)

Correspondence Address: MICHAEL BEST & FRIEDRICH, LLP, 100 E WISCONSIN AVENUE, MILWAUKEE, WI, 53202, US

(21) Appl. No.: 10/801,060

(22) Filed: Mar. 15, 2004

(51) Int. Cl. E05C 3/06

(52) U.S. Cl. 292/201

(57) ABSTRACT

Some embodiments of the present invention provide a latch having a catch, a pawl, and an actuator wheel having first and second protrusions. The first protrusion drives movement of the catch and pawl to selectively engage and disengage a striker. The second protrusion engages a catch abutment surface and a pawl abutment surface to define an opened and closed state of the latch, respectively.

### BACKGROUND OF THE INVENTION

The present invention relates to latches and particularly to latches having a catch that retains a striker. More particularly, the present invention relates to power-closing latches for use, for example, on a trunk, hatchback, door, or other portion of a vehicle where the catch's engagement with the striker draws the portion of the vehicle to a closed position.

Conventional latches, particularly those used for vehicle portions as described above, typically include elaborate linkages for coordinating the movement of a catch and a pawl of the latch. These linkages typically cause the catch to engage a striker to draw the trunk closed. The linkages also selectively move the pawl to control movement of the catch.

### SUMMARY OF THE INVENTION

The many parts of conventional linkages of power-closing latches can fatigue and fail. A power-closing latch that utilizes relatively few parts would be welcomed by users of such latches.

Some embodiments of the present invention provide a latch comprising a catch having a catch lock surface, a catch cam surface, and a catch abutment surface; a pawl moveable with respect to the catch and including a pawl lock surface, a pawl cam surface, and a pawl abutment surface; and an actuator wheel rotatable about an actuator axis and having two projections projecting from a surface of the wheel, wherein the catch and pawl are moveable between a first position wherein the pawl lock surface is in engagement with the catch lock surface and a second position wherein the pawl lock surface is out of engagement with the catch lock surface, rotation of the wheel in a first direction causing a first of the two projections to engage the pawl cam surface and move the pawl from the first position to the second position and causing a second of the two projections to engage the catch abutment surface, and rotation of the wheel in a second direction causing the first of the two projections to engage the catch cam surface and move the catch from the second position to the first position and causing the second of the two projections to engage the pawl abutment surface.

In some embodiments of the present invention, a latch is provided, and comprises a catch having a catch abutment, a stop surface, and a hook portion, wherein the catch is movable between a first catch position wherein the hook portion is positioned to retain a striker and a second catch position wherein the hook portion is positioned to release the striker; a pawl having a pawl abutment and a notch, wherein the pawl is movable between a first pawl position wherein the notch is in engagement with the stop surface of the catch and a second pawl position wherein the notch is out of engagement with the stop surface of the catch; and a rotating actuator wheel having two protrusions, wherein the wheel is rotatable in a first direction wherein the first protrusion engages a pawl cam surface of the pawl causing the pawl to move from the first pawl position to the second pawl position, permitting the catch to move to the second catch position and where the catch abutment engages the second protrusion of the actuator wheel, and a second direction wherein the first protrusion engages a catch cam surface of the catch causing the catch to move from the second catch position to the first catch position, permitting the pawl to move to the first pawl position and where the pawl abutment engages the second protrusion of the actuator wheel.

Some embodiments of the present invention call for a latch comprising a catch including a catch lock surface and a catch cam surface; a pawl moveable with respect to the catch and including a pawl lock surface and a pawl cam surface; and an actuator wheel rotatable about an actuator axis and having an actuator portion formed on the wheel, wherein the catch and pawl are moveable between a first position wherein the pawl lock surface is in engagement with the catch lock surface and a second position wherein the pawl lock surface is out of engagement with the catch lock surface, rotation of the wheel in a first direction causing the actuator portion to engage the pawl cam surface and move the pawl from the first position to the second position, and rotation of the wheel in a second direction causing the actuator portion to engage the catch cam surface and move the catch from the second position to the first position.

### BRIEF DESCRIPTION OF THE DRAWINGS

The detailed description particularly refers to the accompanying figures in which:

FIG. 1 is a front perspective view of a latch according to an embodiment of the present invention, showing a catch having a hook portion in engagement with a striker, a pawl preventing movement of the catch, an actuator wheel positioned between the catch and the pawl, and an electric motor coupled to the actuator wheel through a worm gear arrangement;

FIG. 2 is a rear perspective view of the latch of FIG. 1;

FIG. 3 is a plan view of the latch of FIGS. 1 and 2, showing the catch in a latched state with the pawl in a position preventing movement of the catch;

FIG. 4 is a plan view of the latch in FIGS. 1 and 2, taken from the opposite side of the latch shown in FIG. 3;

FIG. 5 is a plan view of the latch in FIGS. 1 and 2, showing the catch in the latched state with the pawl positioned to prevent movement of the catch and the actuator wheel rotated approximately 30° clockwise from its position in FIG. 3;

FIG. 6 is a plan view of the latch in FIGS. 1 and 2, showing the actuator wheel rotated approximately 60° clockwise from its position in FIG. 5 and a first projection of the actuator wheel moving the pawl to a position allowing movement of the catch to an unlatched state;

FIG. 7 is a plan view of the latch in FIGS. 1 and 2, showing the actuator wheel further rotated clockwise from its position in FIG. 6 and the catch rotated counter-clockwise to the unlatched state;

FIG. 8 is a plan view of the latch in FIGS. 1 and 2, showing the actuator wheel rotated back approximately 30° counter-clockwise from its position in FIG. 7 and the first projection of the actuator wheel engaging the catch;

FIG. 9 is a plan view of the latch in FIGS. 1 and 2, showing the actuator wheel further rotated approximately 90° counter-clockwise from its position in FIG. 8, thus having rotated the catch clockwise back to its latched state to permit the pawl to engage the catch;

FIG. 10 is a plan view of the latch in FIGS. 1 and 2, taken from the opposite side of the latch shown in FIG. 3, and showing a lost-motion member of the catch rotated clockwise and off of a lost-motion stop;

FIG. 11 is a plan view of the latch in FIGS. 1 and 2, showing the lost-motion member rotated back counter-clockwise from its position in FIG. 10 to abut the lost-motion stop; and

FIG. 12 is a plan view of the striker positioned within a notch or throat of a latch body and showing a three-position switch in various positions relating to the position of the striker in the notch.

### DETAILED DESCRIPTION

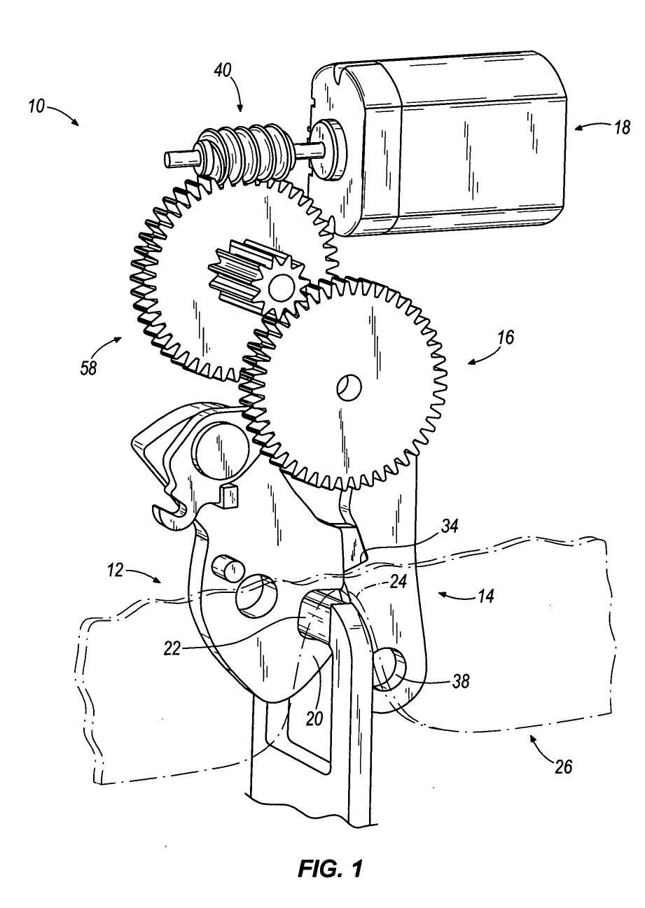

With reference to FIG. 1, a latch 10 according to an embodiment of the present invention includes a catch 12, a pawl 14, and an actuator wheel 16. The actuator wheel 16 is driven by an electric motor 18 that is coupled to the actuator wheel 16 through a worm gear arrangement including a worm gear 40 and an intermediate gear wheel 58. In other embodiments, the motor 18 is drivably connected to the actuator wheel 16 in other ways, including arrangements in which the worm gear 40 or a pinion is connected directly to the actuator wheel 16, arrangements in which the motor 18 is connected directly to the actuator wheel 16, arrangements in which a cable or chain drive is connected to the actuator wheel 16, and the like, while still falling within the spirit and scope of the present invention.

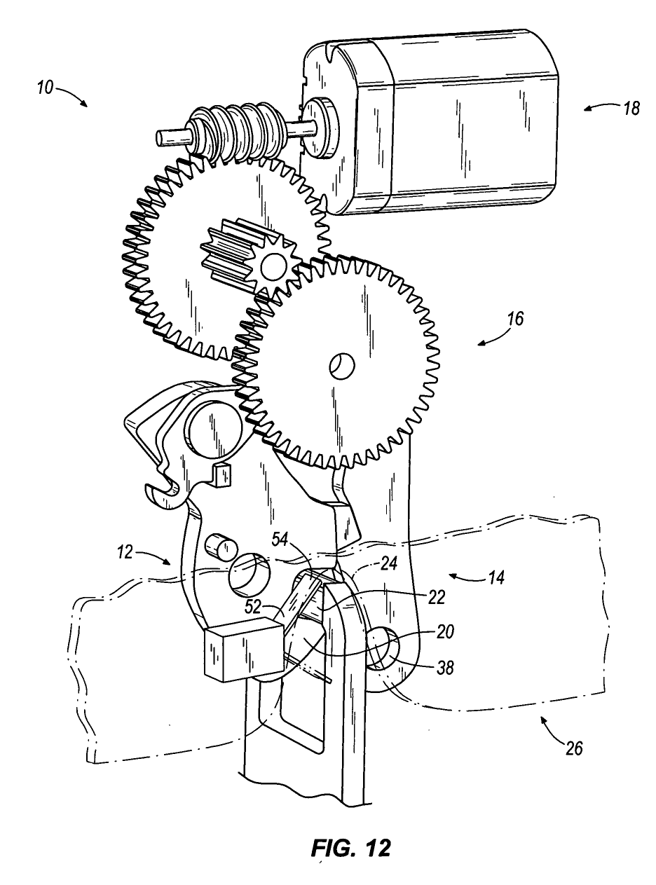

The catch 12 includes a hook portion 20 that retains a striker 22 in a notch or throat 24 of a latch body 26 (see FIG. 12). However, the catch 12 and striker 22 can be shaped in many other ways (in which the catch 12 receives and retains the striker 22) while still falling within the spirit and scope of the present invention. For example, the striker 22 can be substantially straight, U-shaped, L-shaped, or can have any other shape received within a recess or other aperture in the catch 12. Further, it should be noted that the throat 24 and latch body 26 can be omitted and the catch 12 mounted directly to a door frame, trunk frame, or other structure while still falling within the spirit and scope of the present invention.

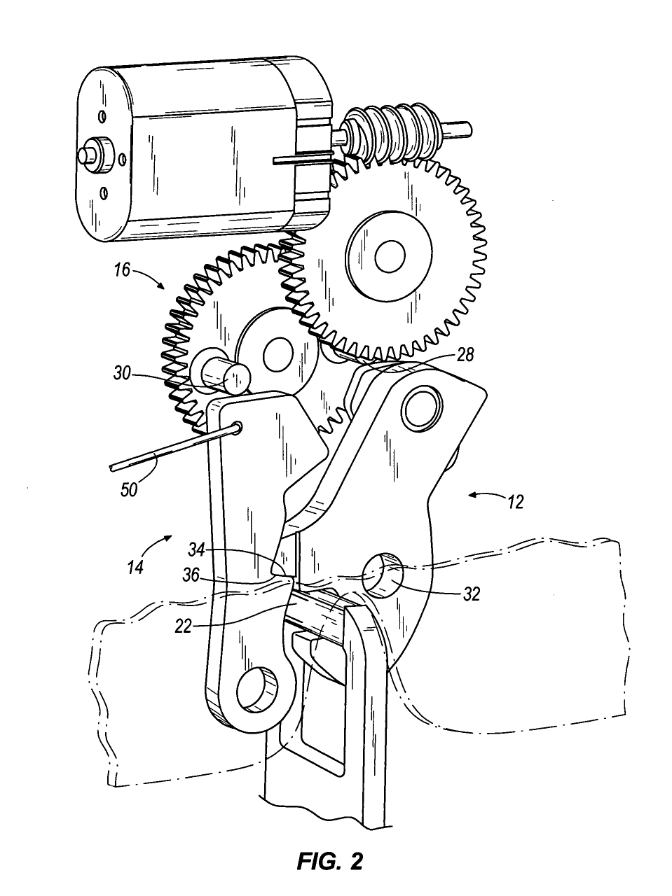

Referring to FIG. 2, the actuator wheel 16 in the illustrated embodiment includes a first protrusion 28 and a second protrusion 30. Rotation of the actuator wheel 16 causes the protrusions 28, 30 to engage various surfaces of the catch 12 and pawl 14 and control their movement, as will be further discussed below.

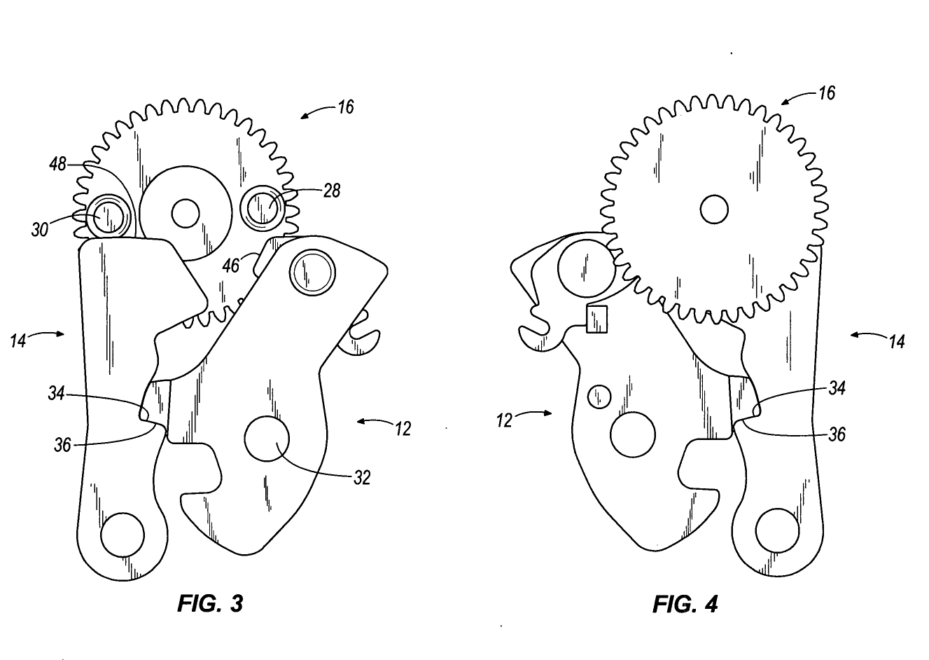

From the perspective shown in FIGS. 2 and 3, the catch 12 is biased in a counter-clockwise direction around a catch pivot 32. With the catch 12 positioned as shown in FIGS. 1-5, the striker 22 is captured in the notch 24 of the latch body 26 by the hook portion 20 of the catch 12 (see particularly FIG. 1). However, from the perspective shown in FIGS. 2, 3, and 5, the catch 12 is biased in a counter-clockwise direction around a catch pivot 32. As viewed from the perspective shown in FIGS. 2, 3, and 5, if the catch 12 is rotated in a counter-clockwise direction, the striker 22 is free to move out of the notch 24 and the hook portion 20, as will be discussed in further detail below. In some embodiments, the catch 12 need not be biased in the counter-clockwise direction. Instead, the motion of the striker 22 out of the hook portion 20 of the catch 12 can be relied on to rotate the catch 12 and still fall within the spirit and scope of the present invention. In FIGS. 1-5, a pawl lock surface 34 is in engagement with a catch lock surface 36 to prevent rotation of the catch 12 in a counter-clockwise (clockwise in FIG. 4) direction. The interaction of these elements will be further discussed in detail below.

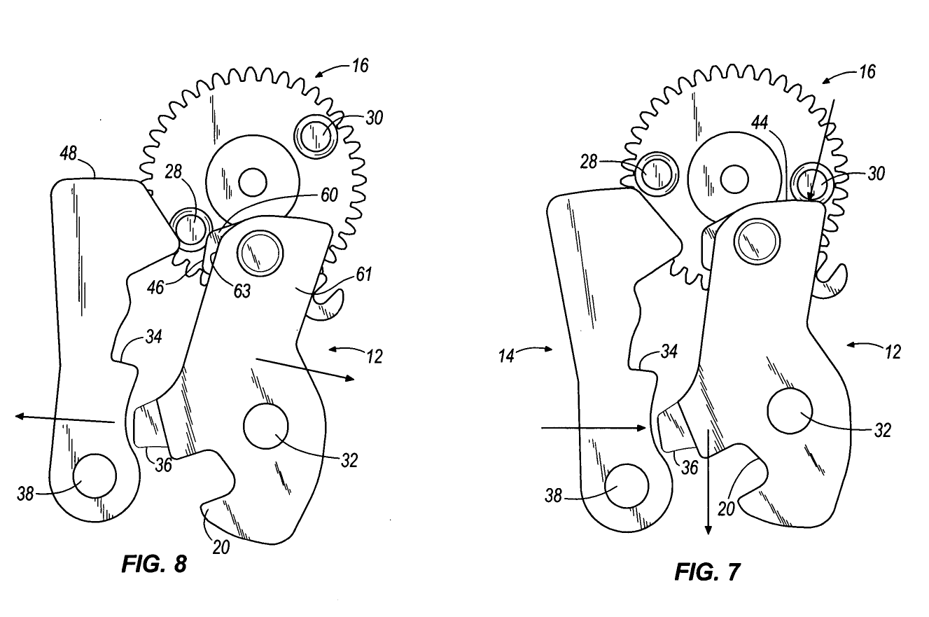

As shown in FIGS. 6 and 7, with the pawl 14 rotated counter-clockwise about a pawl pivot 38, the pawl lock surface 34 disengages the catch lock surface 36 and the natural bias of the catch 12 to rotate in a counter-clockwise direction takes over and the catch 12 rotates counter-clockwise. The catch 12 is biased in a counter-clockwise direction around the catch pivot 32 by any one of a number of methods, as will be readily apparent to those of ordinary skill in the art. In some embodiments for example, the latch 10 includes a torsion spring (not shown) around the catch pivot 32 to bias the catch 12 in a clockwise direction. In other embodiments, the catch 12 can be rotatably biased by one or more extension or compression springs connected to the catch 12 a distance from the catch pivot 32 (and connected to an adjacent housing or other structure). Again, the specific interaction of the catch 12 and pawl 14 elements will be further discussed in detail below.

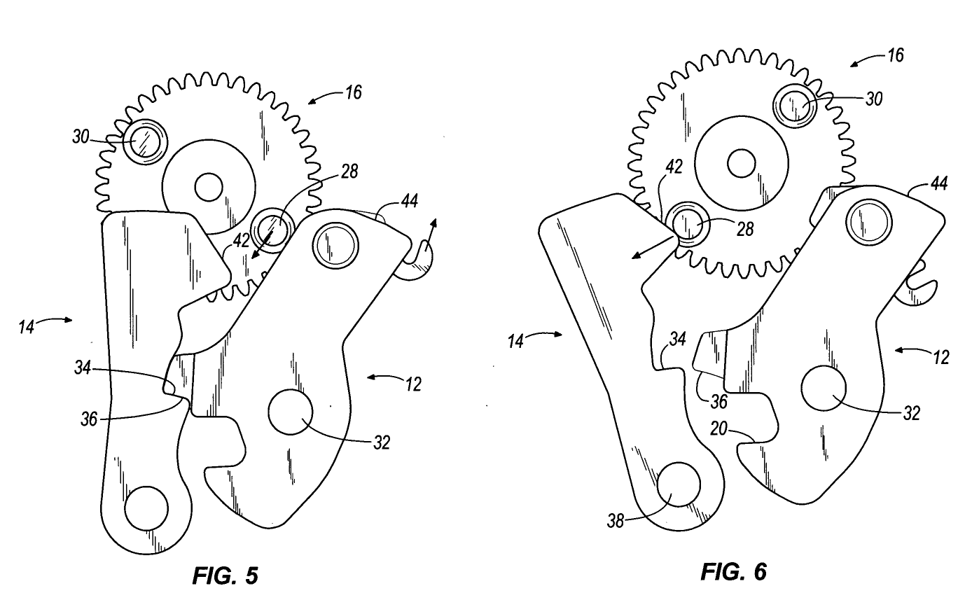

In FIGS. 3-6, the illustrated latch 10 is moved from its latched to its unlatched state. Rotation of the actuator wheel 16 in a clockwise direction (counter-clockwise in FIG. 4) causes the latch 10 to unlatch. Particularly, referring to FIGS. 5 and 6, rotation of the actuator wheel 16 in a clockwise direction causes the first protrusion 28 of the actuator wheel 16 to engage a pawl cam surface 42 of the pawl 14. This causes the pawl lock surface 34 to move out of engagement with the catch lock surface 36 (FIG. 6).

As shown in FIG. 6, clockwise rotation of the actuator wheel 16 causes the first protrusion 28 to push against the pawl cam surface 42, thereby rotating the pawl 14 about the pawl pivot 38 in a counter-clockwise direction. Referring to FIG. 7, with the pawl lock surface 34 out of engagement with the catch lock surface 36, the catch 12 is free to rotate in a counter-clockwise direction around the catch pivot 32, thereby positioning the hook portion 20 of the catch 12 to permit the striker 22 to move out of the notch 24 of the latch body 26. While the figures show the pawl lock surface 34 and catch lock surface 36 formed in a particular way, the catch 12 and pawl 14 can engage one another in any manner to releasably restrain catch rotation. The catch 12 and pawl 14 can have any shape capable of releasable engagement between the catch 12 and pawl 14, providing cam and abutment surfaces discussed herein, and in which the catch 12 can receive and retain a striker as described above.

At the same time, the second protrusion 30 of the actuator wheel 16 contacts a catch abutment surface 44, preventing further clockwise rotation of the actuator wheel 16. As shown in FIG. 7, with the latch 10 in this position, the pawl 14 is rotated in the counter-clockwise position around the pawl pivot 38 a sufficient distance so that the first protrusion 28 clears the pawl 14 if the actuator wheel 16 is rotated back counter-clockwise. Engagement of the catch 12 against the pawl 14 prevents the pawl 14 from rotating back clockwise when the latch 10 is in the unlatched state so that the actuator wheel 16 can rotate back counter-clockwise.

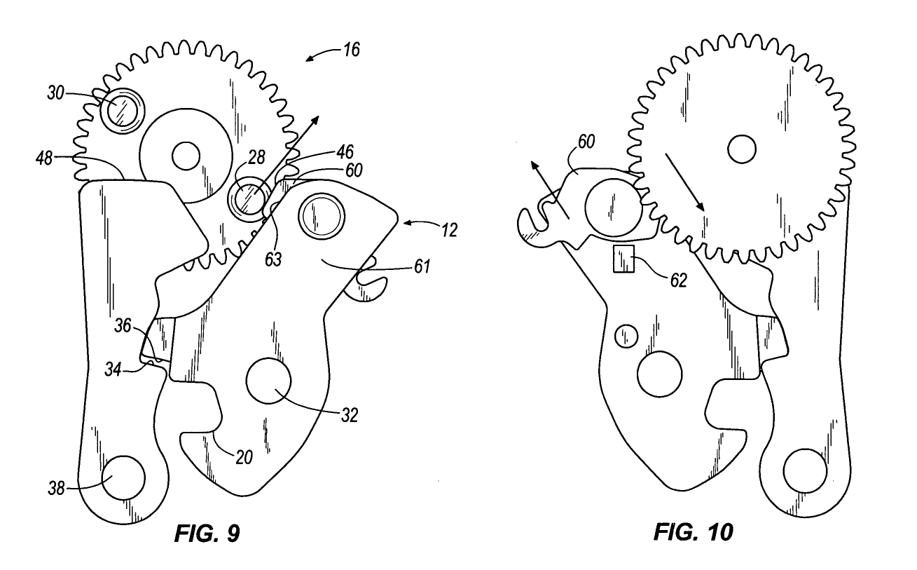

Referring to FIGS. 8 and 9, rotation of the actuator wheel 16 back in a counter-clockwise direction causes the first protrusion 28 to engage a catch cam surface 46 of the catch 12 and rotate it clockwise sufficiently to allow the catch lock surface 36 to clear the pawl lock surface 34. The pawl 14, which is biased in a clockwise direction about the pawl pivot 38, is then free to rotate clockwise. The pawl lock surface 34 then again engages the catch lock surface 36 and prevents the catch 12 from rotating back in a counter-clockwise direction, even when the first protrusion 28 clears the catch cam surface 46, as shown in FIG. 3. The actuator wheel 16 reaches its limit of counter-clockwise rotation when the second protrusion 30 eventually engages a pawl abutment surface 48, as also shown in FIG. 3. The latch 10 is then in its latched state and the unlatching cycle discussed above can again begin.

As discussed, counter-clockwise rotation of the actuator wheel 16 causes the first protrusion 28 to engage the catch cam surface 46 of the catch 12 and force the catch 12 in a clockwise rotation around the catch pivot 32. Counter-clockwise rotation of the actuator wheel 16 and the resulting clockwise rotation of the catch 12 can be initiated upon movement of the striker 22 into the hook portion 20 of the catch 12. For example, as will be further discussed below, an electronic switch or other sensor can be used to detect the position of striker 22 and to initiate counter-clockwise rotation of the actuator wheel 16 to power rotation of the catch 12 and draw the striker 22 up and into the hook portion 20 of the catch 12. However, in some embodiments, such initiation can be eliminated and the latch 10 can be latched by relying on movement of the striker 22 into the catch 12. In this way, the catch 12 is rotated by the striker 22 until the pawl 14 re-engages the catch 12.

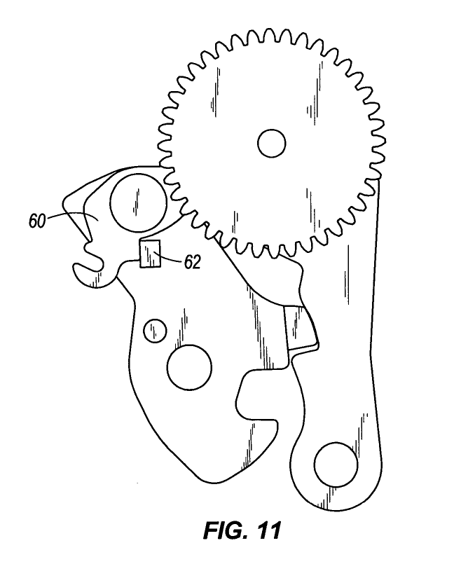

As shown in FIGS. 8 and 9, in some embodiments the catch cam surface 46 is part of a lost motion member 60 of the catch 12. The catch cam surface 46 can be defined as part of the body 61 of the catch 12 (e.g., defined by an edge 63 of the catch body 61 itself), thereby eliminating the lost motion member 60. However, in other embodiments, the catch cam surface 46 is defined by an element movable with respect to the rest of the catch 12. By way of example only, the catch 12 in the illustrated embodiment includes a lost motion member 60 defining the catch cam surface 46 which aids in the practical functioning of the latch 10. As shown in FIG. 9, the first protrusion 28 of the actuator wheel 16 engages this lost motion member 60, rotating the catch 12 clockwise slightly beyond the rotation necessary to engage the catch lock surface 36 with the pawl lock surface 34. This “over-travel” ensures that the catch lock surface 36 “clears” the pawl lock surface 34. As shown in FIG. 11 (viewed from the opposite side as shown in FIG. 9), the lost motion member 60 engages a lost motion stop 62 upon rotation of the catch 12 by the first protrusion 28. Thus, as view in FIG. 9, when the first protrusion 28 engages the lost motion member 60, it rotates the catch 12 along with the lost motion member 60 as if they were a unitary rigid body. In other embodiments, the lost motion member 60 can move with respect to the rest of the catch 12 when rotated by the first protrusion 28 in this manner, but is limited in such motion to still provide a surface against which the pawl 14 can transmit force to rotate the catch 12. When the first protrusion 28 clears the lost motion member 60, the catch 12 can rotate back slightly counter-clockwise (see FIG. 9) to take up the over-travel and engage the catch lock surface 36 on the pawl lock surface 34 (see FIG. 3).

Referring to FIG. 3, when the actuator wheel 16 begins rotating clockwise to initiate unlatching of the latch 10, it engages the lost motion member 60 (if employed), which moved into the path of the first protrusion 28 when the over-travel was taken up as described above. When the first protrusion 28 engages the lost motion member 60, it rotates the lost motion member 60 relative to the catch body 61 and off of the lost motion stop 62 as shown in FIG. 10. This allows the first protrusion 28 to pass the catch cam surface 46 with relatively little resistance. If the catch cam surface 46 were formed directly as part of a protrusion formed integrally with the catch 12, the over-travel condition discussed above can still be achieved. However, in some embodiments having no lost motion member 60, the first protrusion 28 can have an amount of interference with the catch 12 upon unlatching (in some cases, against the force biasing the catch 12 into its released state). When employed, the lost motion member 60 can provide quick, relatively low force unlatching while still allowing for over-travel upon latching.

The actuator wheel 16 can be driven by any of several devices and methods as will be readily apparent to those of ordinary skill in the art. As shown in FIG. 1, some embodiments of the present invention employ an electric motor 18 that drives the actuator wheel 16 through a worm gear 40 and intermediate gear wheel 58. In this way, the electric motor 18 illustrated in the figures electrically unlatches the latch 12 as shown in FIGS. 3-7 to release the striker 22 from the catch 12 and electrically latches the latch 10 and draws the striker 22 up into the notch 24 of the latch body 26 as shown in FIGS. 8 and 9. However, the actuator wheel 16 can be driven by other than electrical devices. Further, the latch 10 can be unlatched by rotating the pawl 14 about the pawl pivot 38 in any other manner, such as by a release cable 50 attached to the pawl 14 as shown in FIG. 2, by a linkage attached to the pawl 14, by direct actuation of the pawl 14 using any conventional actuator, and the like. In the illustrated embodiment for example, when the cable 50 is pulled, the pawl 14 will rotate counter-clockwise out of the way of the catch 12 and effect substantially the same movement to the latch 10 as the actuator wheel 16 described above. In this embodiment, the catch 12 will rotate counter-clockwise under its biasing force and release the striker 22 without rotation of the actuator wheel 16.

When the electric motor 18 is used to electrically drive the actuator wheel 16 (or other rotating member as described in greater detail below), a position switch 52 such as that shown in FIG. 12 can be utilized to control actuation of the electric motor 18. Although any type of position switch or sensor can be employed for this purpose, the position switch 52 illustrated in FIG. 12 includes a switch arm 54 that moves in response to movement of the striker 22 into the notch 24 of the latch body 26. The position switch 52 shown in FIG. 12 is a three-position switch and “reads” three positions of the switch arm 54. A first position of the switch arm 54, shown in phantom lines, indicates that the striker 22 is out of the notch 24 and the latch 10 is open. When the striker 22 begins to enter the notch 24, it contacts the switch arm 54, moving the switch arm 54 and indicating to the position switch 52 that the latch 10 is being closed. This sends a signal to the electric motor 18 to rotate the actuator wheel 16 to cause the catch 12 to rotate and draw the striker 22 into the notch 24 as shown in FIGS. 8 and 9. When the striker 22 has been drawn sufficiently into the notch 24, the switch arm 54 will be moved to a third position shown in solid lines in FIG. 12, indicating that the latch 10 is closed. At this point, the electric motor 18 will receive a signal from the position switch 52 indicating that the latch 10 is closed and that further rotation of the actuator wheel 16 is not required.

As mentioned above, and referring to FIG. 3, when the actuator wheel 16 has completely rotated so that the first protrusion 28 has rotated the catch 12 to completely draw the striker 22 into the notch 24, the second protrusion 30 engages the pawl abutment surface 48, indicating that the latch 10 is closed. Therefore, the position switch 52 need not necessarily be a three-position switch as shown in FIG. 12, but can instead simply indicate a single position when the striker 22 is entering the notch 24 and power-closing of the latch 10 is to begin. In this case, engagement of the second protrusion 30 against the pawl abutment surface 48 will prevent further rotation of the actuator wheel 16 when the latch 10 is fully closed. An overload sensor on the electric motor 18 (or elsewhere in a power supply circuit associated with the electric motor 18) can then be utilized to turn off the motor 18 because further rotation of the actuator wheel 16 is not needed.

Similarly, upon opening of the latch 10, as shown in FIGS. 3-7, the second protrusion 30 engages the catch abutment surface 44 after the actuator wheel 16 has rotated to an extent sufficient to completely open the latch 10. Therefore, the engagement of the second protrusion 30 against the catch abutment surface 44 will prevent the electric motor 18 from further rotating the actuator wheel 16. Again, an overload sensor on the electric motor 18 can be utilized to indicate that the latch 10 is fully opened and that no further rotation of the actuator wheel 18 is necessary. In this way, the three-position switch 52, one position of which indicates a “latch open” position as discussed above, is not necessary and a dual position switch can be employed.

In addition to the mechanical switch, whether it be a three-position switch or a two-position switch, one or more presence sensors (e.g., Hall effect sensors, photodiodes, etc.) can be employed in the throat of the latch body to detect when the striker 22 enters the throat. A presence detector can provide much the same function as a dual-position switch. Presence of the striker 22 in the throat of the latch body can be detected by the presence sensors in a manner known to one of ordinary skill in the art. The sensors can then trigger the electric motor 18 to drive the actuator wheel 16 in a counter-clockwise direction and cause the first protrusion 28 to rotate the catch 12 in a clockwise direction and draw the striker 22 into the hook portion 20 of the catch 12.

It should be noted that rotation of the actuator wheel 16 can be controlled without the existence of the second protrusion 30 in the illustrated embodiment. In some embodiments, wheel rotation can be controlled (including stopping) in a number of manners, such as by controlling motion of the motor 18 to stop turning the wheel 16 when a desired rotational position of the wheel 16 is sensed, by using one or more switches, timers, and/or optical, mechanical, or other position sensors to determine when the motor, striker, catch, and/or pawl are in a particular position, and the like.

The embodiment shown in the figures includes the actuator wheel 16 to control the movement of the catch 12 and pawl 14. In some embodiments, another rotating or pivoting member other than a wheel can be used. By way of example only, a bar-like structure that is pivotable about a point along its length (e.g., a middle location) can contact the various cam surfaces 42, 46 to control movement of the catch 12 and pawl 14. Alternatively, the bar-like structure can pivot at one of its ends with the other end selectively contacting the catch 12 and pawl 14 to control their movement. Other examples of elements that can be rotated to perform the same or similar functions as the actuator wheel 16 with its protrusions 28, 30 include, without limitation, semi-circular elements, V or L-shaped levers, irregularly-shaped elements, and the like—any of which can have surfaces located to contact and move the catch 12 and pawl 14 when rotated as described herein. In general, any element or structure that is movable or rotatable and shaped to selectively contact the catch 12 and pawl 14 to control their movement as described herein falls within the spirit and scope of the present invention. The actuator wheel 16 with its protrusions 28 and 30 is included in one embodiment of the invention.

The foregoing description of the present invention has been presented for purposes of illustration and description. Furthermore, the description is not intended to limit the invention to the forms disclosed herein. Consequently, variations and modifications commensurate with the above teachings, and the skill or knowledge of the relevant art, are within the scope of the present invention. The embodiments described herein are further intended to explain best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. A latch comprising:
a catch having a catch lock surface, a catch cam surface, and a catch abutment surface;
a pawl moveable with respect to the catch and including a pawl lock surface, a pawl cam surface, and a pawl abutment surface; and
an actuator wheel rotatable about an actuator axis and having two projections projecting from a surface of the wheel, wherein the catch and pawl are moveable between a first position wherein the pawl lock surface is in engagement with the catch lock surface and a second position wherein the pawl lock surface is out of engagement with the catch lock surface, rotation of the wheel in a first direction causing a first of the two projections to engage the pawl cam surface and move the pawl from the first position to the second position and causing a second of the two projections to engage the catch abutment surface, and rotation of the wheel in a second direction causing the first of the two projections to engage the catch cam surface and move the catch from the second position to the first position and causing the second of the two projections to engage the pawl abutment surface.

2. The latch of claim 1 further comprising a spring biasing the catch to pivot toward the second position.

3. The latch of claim 1, wherein the two projections project from a surface of the wheel that is perpendicular to the actuator axis.

4. The latch of claim 3, wherein the two projections are disposed approximately 180 degrees from each other with respect to the actuator axis.

5. The latch of claim 3, wherein the two projections are approximately equidistant from the actuator axis.

6. The latch of claim 1, further comprising a striker retained within a hook portion of the catch when the catch is in the first position.

7. The latch of claim 1, wherein the catch pivots in a plane that is substantially perpendicular to the actuator axis.

8. The latch of claim 7, wherein the pawl moves in a plane that is substantially perpendicular to the actuator axis.

9. A latch comprising:
a catch having a catch abutment, a stop surface, and a hook portion, the catch being movable between a first catch position wherein the hook portion is positioned to retain a striker and a second catch position wherein the hook portion is positioned to release the striker;
a pawl having a pawl abutment and a notch, the pawl being movable between a first pawl position wherein the notch is in engagement with the stop surface of the catch and a second pawl position wherein the notch is out of engagement with the stop surface of the catch; and
a rotating actuator wheel having two protrusions, the wheel being rotatable in a first direction wherein the first protrusion engages a pawl cam surface of the pawl causing the pawl to move from the first pawl position to the second pawl position, permitting the catch to move to the second catch position and where the catch abutment engages the second protrusion of the actuator wheel, and a second direction wherein the first protrusion engages a catch cam surface of the catch causing the catch to move from the second catch position to the first catch position, permitting the pawl to move to the first pawl position and where the pawl abutment engages the second protrusion of the actuator wheel.

10. The latch of claim 9, wherein the catch is biased toward the second catch position.

11. The latch of claim 10, wherein the pawl is biased toward the first pawl position.

12. The latch of claim 11, further comprising two springs, each of the two springs applying a biasing force to one of the catch and the pawl.

13. The latch of claim 9, wherein in the second catch position, the catch prevents the pawl from moving from the second pawl position to the first pawl position.

14. The latch of claim 9, wherein the actuator wheel is rotated by an electric motor via a worm gear.

15. The latch of claim 9, wherein the pawl is moveable from the first pawl position to the second pawl position by a cable connected to the pawl.

16. The latch of claim 9, further including a switch actuated by the striker, the switch controlling rotation of the actuator wheel.

17. The latch of claim 16, wherein the switch is a three-position switch.

18. The latch of claim 9, wherein the striker is drawn into the hook portion of the catch when the catch moves from its second position to its first position.

19. A latch comprising:
a catch including a catch lock surface and a catch cam surface;
a pawl moveable with respect to the catch and including a pawl lock surface and a pawl cam surface; and
an actuator wheel rotatable about an actuator axis and having an actuator portion formed on the wheel, wherein the catch and pawl are moveable between a first position wherein the pawl lock surface is in engagement with the catch lock surface and a second position wherein the pawl lock surface is out of engagement with the catch lock surface, rotation of the wheel in a first direction causing the actuator portion to engage the pawl cam surface and move the pawl from the first position to the second position, and rotation of the wheel in a second direction causing the actuator portion to engage the catch cam surface and move the catch from the second position to the first position.
